(19) United States
(12) Patent Application Publication
(10) Pub. No.: US 2022/0363220 A1
(43) Pub. Date: Nov. 17, 2022

(54) Steering Wheel Lock Device

(71) Applicant: Paul Muanvong, East Gwillimbury (CA)

(72) Inventor: Paul Muanvong, East Gwillimbury (CA)

(21) Appl. No.: 17/321,291

(22) Filed: May 14, 2021

(51) Int. Cl. B60R 25/022

(52) U.S. Cl. CPC B60R 25/0221

(57) ABSTRACT

A device including a first section, a second section, and a stopper means. The first section includes a first handle and a first clamp half, and the second section includes a second handle and a second clamp half. The device is useful for clamping to any area of a steering wheel to, at least substantially, inhibit unauthorized movement of the steering wheel. When the first clamp half and the second clamp half are attached to a driver-door side of the wheel-section, the device may at least substantially inhibit unauthorized entrance to the vehicle.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicle accessories of existing art and more specifically relates to an anti-theft device for a vehicle.

### RELATED ART

Unfortunately, vehicle theft is a common problem in many countries all over the world, and as such, vehicle protection has been a widespread concern among vehicle owners and users. Most new vehicles come equipped with vehicle alarms to act as a deterrent and hopefully alert passersby as to the theft. However, vehicle alarms are a weak solution, as they do not physically prevent unauthorized entrance of the vehicle, nor do they prevent the thief from starting the vehicle and driving away. Further, vehicle alarms often sound for reasons unrelated to a theft (such as a loud noise or accidental touch), and as such, we have grown accustomed to hearing vehicle alarms and ignoring them.

Attempts have been made to solve this problem by utilizing physical means inside the vehicle to protect it from theft. However, these attempts have not been satisfactory as the devices are easily broken or cut, thus rendering them useless; are bulky and cumbersome; and/or take too much time to install and remove from the steering wheel. In addition, the current devices do not prevent unauthorized entrance to the vehicle. Thus, a suitable solution is desired.

### SUMMARY OF THE INVENTION

In view of the foregoing disadvantages inherent in the known anti-theft devices for vehicles art, the present disclosure provides a novel steering wheel lock device. The general purpose of the present disclosure, which will be described subsequently in greater detail, is to provide a means of inhibiting unauthorized movement of a steering wheel in a vehicle and inhibiting unauthorized entrance into the vehicle.

A device is disclosed herein. The device may at least substantially inhibit unauthorized movement of a steering wheel in a vehicle; the steering wheel including a wheel-section and a center-section. The device includes a first section which may include a first handle and a first clamp half, and a second section which may include a second handle and a second clamp half. The second section may be pivotably attached to the first section such that movement of the first handle and the second handle relative to each other selectively moves the first clamp half and the second clamp half between an open-clamp position and a locked-clamp position. The locked-clamp position may include the first clamp half and the second clamp half being clamped to an area of the wheel-section of the steering wheel, thereby at least substantially inhibiting the unauthorized movement of the steering wheel. Further, a stopper means may be attached to one of the first section and the second section. The stopper means may be configured for contact with the wheel-section of the steering wheel when the first clamp half and the second clamp half are clamped to the wheel-section.

According to another embodiment, a method of using a device for at least substantially inhibiting unauthorized movement of a steering wheel in a vehicle is also disclosed herein. The method includes providing the device as above; placing the first clamp half and the second clamp half about any area of wheel-section of the steering wheel, the first clamp half and the second clamp half being in the open-clamp position; moving the first handle and the second handle relative to each other to place the first clamp half and the second clamp half into the locked-clamp position; clamping the first clamp half and the second clamp half onto said any area of wheel-section of the steering wheel; and substantially inhibiting movement of the steering wheel.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a steering wheel lock device, constructed and operative according to the teachings of the present disclosure.

FIG. 1 is a perspective view of the device during an ‘in-use’ condition, illustrating the device attached to a steering wheel, according to an embodiment of the disclosure.

FIG. 2 is a top perspective view of the device of FIG. 1, illustrating a locked-clamp position, according to an embodiment of the present disclosure.

FIG. 3 is a top perspective view of the device of FIG. 1, illustrating an open-clamp position, according to an embodiment of the present disclosure.

FIG. 4 is a perspective view of the device of FIG. 1 during an ‘in-use’ condition, illustrating the device attached to a driver-door side of the steering wheel, according to an embodiment of the present disclosure.

FIG. 5 is a front perspective view of the device of FIG. 1 in the open-clamp position about the steering wheel, according to an embodiment of the present disclosure.

FIG. 6 is a front perspective view of the device of FIG. 1 clamped to the steering wheel in the locked-clamp position, according to an embodiment of the present disclosure.

FIG. 7 is a flow diagram illustrating a method of using a device for at least substantially inhibiting unauthorized movement of a steering wheel in a vehicle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an anti-theft device for a vehicle and more particularly to a steering wheel lock device as used to protect a vehicle from theft by substantially inhibiting unauthorized movement of a steering wheel, and further substantially inhibiting unauthorized entrance into the vehicle.

Generally disclosed is a device that is light, small, and simple to use. The device may lock onto a steering wheel, preferably anywhere on the steering wheel, which may prevent the steering wheel from working properly. Further, if the device is placed on a center of the steering wheel, an individual may be unable to enter the vehicle properly. This may be particularly useful for emergency cars, convertible cars, antique cars, or cars/trucks that are being defrosted or warmed and left unattended.

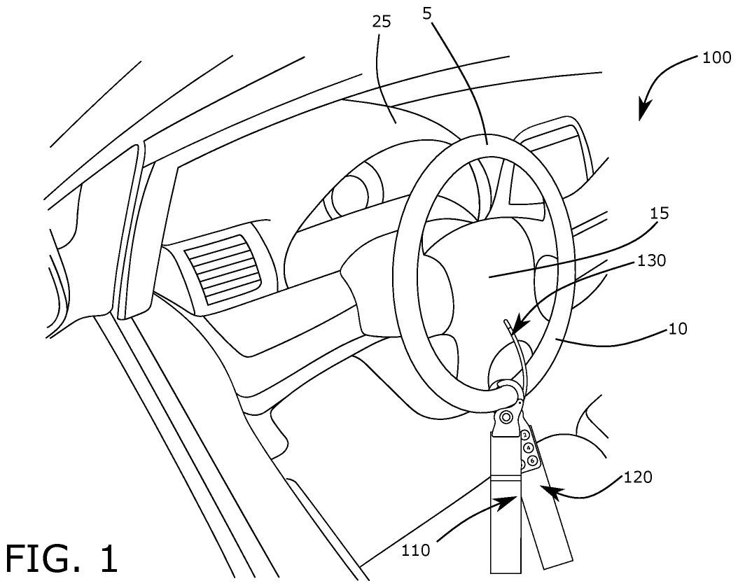

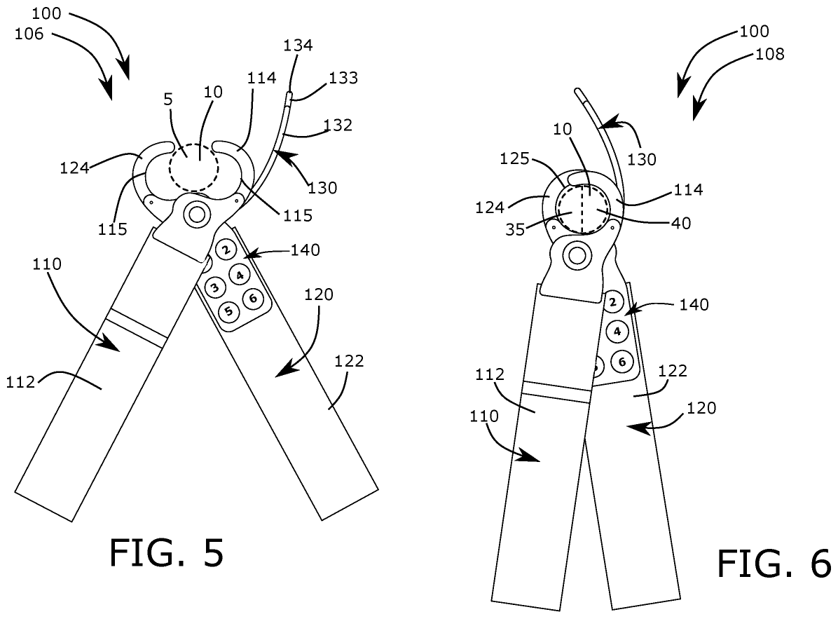

Referring now more specifically to the drawings by numerals of reference, there is shown in FIGS. 1-6, various views of a device for at least substantially inhibiting unauthorized movement of a steering wheel in a vehicle (“device” 100).

FIG. 1 shows the device 100 during an ‘in-use’ condition, according to an embodiment of the present disclosure. As illustrated, the device 100 may include a first section 110, a second section 120, and a stopper means 130. The device 100 may be used for at least substantially inhibiting unauthorized movement of a steering wheel 5 in a vehicle 25. In some embodiments, the device 100 may also be used for substantially inhibiting unauthorized entrance into the vehicle 25. As shown, the steering wheel 5 may include a wheel-section 10 and a center-section 15. However, it should be appreciated that the size, shape and design of the steering wheel 5 is not limited to the configuration shown in this figure, and that the device 100 is contemplated for use with a variety of steering wheel sizes, shapes and designs.

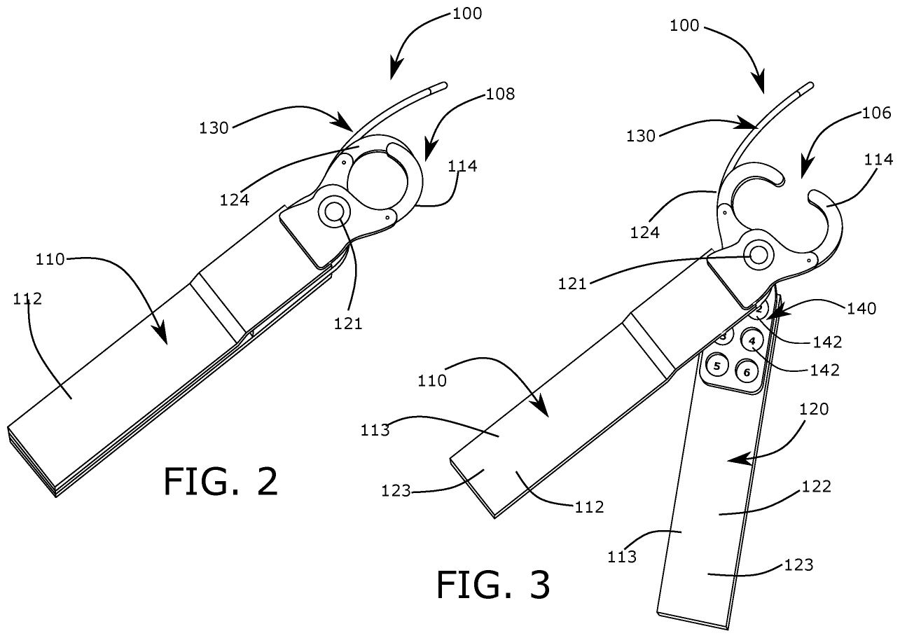

Referring now to FIGS. 2-3 showing various views of the device 100 of FIG. 1, according to an embodiment of the present disclosure. The first section 110 may include a first handle 112 and a first clamp half 114 and the second section 120 may include a second handle 122 and a second clamp half 124. Preferably, the first handle 112 and the second handle 122 may include a substantially flat profile 113 and a rectangular shape 123. The handles (112, 122) preferably comprise material suitable to provide durability and strength. To aid in this, the first section 110 and the second section 120 may include a sturdy, bend resistant material such as a metal material, or a metal alloy material. For example, the metal material may be a steel material, titanium, iron, etc. The shape and profile of the first handle 112 and the second handle 122 may further aid in the durability and strength of the first section 110 and the second section 120. It should be appreciated that other materials, profiles and shapes not listed here are also contemplated.

The second section 120 may be pivotably attached to the first section 110 such that movement of the first handle 112 and the second handle 122 relative to each other selectively moves the first clamp half 114 and the second clamp half 124 between an open-clamp position 106 and a locked-clamp position 108. In some embodiments, the first section 110 and the second section 120 may be attached via a pivot joint. In another embodiment, the first section 110 and the second section 120 may be attached via a hinge 121. When the handles are pulled apart, the clamp halves (114, 124) may be placed in the open-clamp position 106 and when the handles (112, 122) are pushed together, the clamp halves (114, 124) may be placed in the locked-clamp position 108.

Further, as shown, the device 100 may include a numerical lock system 140. The numerical lock system 140 may be configured for selectively unlocking the first clamp half 112 and the second clamp half 122 from the locked-clamp position 108 (and locking the first clamp half 112 and the second clamp half 122 in the locked-clamp position 108). The numerical lock system 140 may utilize a sequence of symbols to selectively unlock the first clamp half 112 and the second clamp half 122. For example, the numerical lock system 140 may utilize a sequence of at least two numbers 142. In some embodiments, the numerical lock system 140 may utilize a sequence of three numbers. Other number sequences are also contemplated, as are other symbols. The numerical lock system 140 may include buttons, dials, etc. for allowing a user to enter the sequence. Entering the sequence into the numerical lock system 140 may then interact with integral mechanical locking means to unlock the first clamp half 112 and the second clamp half 122 from the locked-clamp position 108.

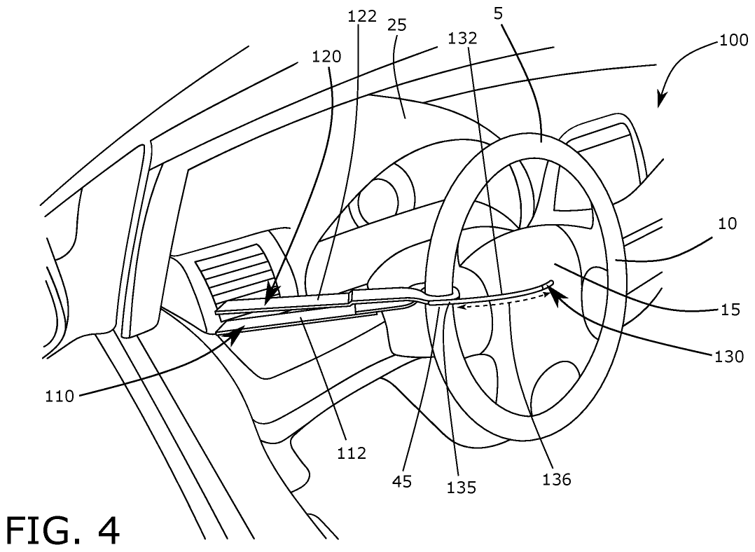

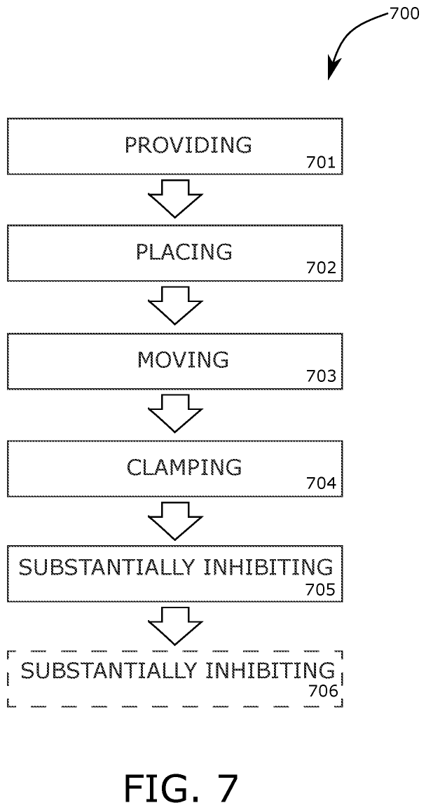

Referring now to FIGS. 4-6 showing various views of the device 100 of FIG. 1, according to an embodiment of the present disclosure. As shown, the first clamp half 114 and the second clamp half 124 may each include a substantially arcuate configuration 115. The first clamp half 114 may be configured to circumscribe a first half 35 of the wheel-section 10 of the steering wheel 5 and the second clamp half 124 may be configured to circumscribe a second half 40 of the wheel-section 10 of the steering wheel 5. Further, as illustrated in FIG. 6, the first clamp half 114 and the second clamp half 124 may form a substantially circular aperture 125 when in the locked-clamp position 108 and the circular aperture 125 may be sized to securely encompass the wheel-section 10 of the steering wheel 5.

Preferably, as above, the first clamp half 114 and the second clamp half 124 may be configured to clamp to a variety of steering wheel sizes. As such, a diameter of the circular aperture 125 may be selectively changed via manipulation of the first handle 112 and the second handle 122, and as such, a point at which the clamp halves (114, 124) are placed into the open-clamp position 106 or the locked-clamp position 108 and a size of the substantially circular aperture 125 when in the locked-clamp position 108 may depend on a size of the steering wheel 5. For example, a steering wheel 5 including a wheel-section diameter of 2 inches may require the circular aperture 125 having a diameter of slightly larger 2 inches—large enough to fully encompass the wheel-section 10, but small enough to be secure on the wheel-section 10. In comparison, a steering wheel 5 including a wheel-section diameter of 1 inch may require the circular aperture 125 to be slightly larger than 1 inch (again, large enough to fully encompass the wheel-section 10, but small enough to be secure on the wheel-section 10).

A user may selectively manipulate the handles (112, 122) to clamp the clamp halves (114, 124) onto the steering-wheel 5 (in the locked-clamp position 108) until the device 100 is secure and does not move. The user may then selectively manipulate the handles (112, 122) to unclamp the clamp halves (114, 124) from the steering wheel 5 until the clamp halves are able to be removed (in the open-clamp position 106). The locked-clamp position 108 may include the first clamp half 114 and the second clamp half 124 being clamped to an area of the wheel-section 10 of the steering wheel 5, thereby at least substantially inhibiting the unauthorized movement of the steering wheel 5. Preferably, the first clamp half 114 and the second clamp half 124 may be configured to clamp onto any area of the wheel-section 10 of the steering wheel 5.

Preferably, when the clamp halves are clamped to any area of the wheel-section 10 it may prevent the steering wheel 5 from properly turning. When first clamp half 114 and the second clamp half 124 are attached to a driver-door side 45 of the wheel-section 10 in the locked-clamp position 108, the first handle 112 and the second handle 122 may at least substantially inhibit unauthorized entrance to the vehicle 25. For example, in this instance, the first handle 112 and the second handle 122 may extend at an angle relative to the steering wheel 5 and toward a driver door of the vehicle 25 which may prevent an intruder from being able to enter the vehicle 25. In some examples, the angle may be between a 30-40 degree angle.

Further, in some embodiments, when the first clamp half 114 and the second clamp half 124 are attached to a bottom-center of the wheel-section 10 of the steering wheel 5 in the locked-clamp position 108 (as shown in FIG. 1), at least one of the first handle 112 and the second handle 122 may be wedged between a driver seat of the vehicle 25 and the steering wheel 5 and this may further inhibit unauthorized entrance into the vehicle 25 as an intruder may not be able to sit in the driver seat. Whether one or both of the handles (112, 122) are wedged between a driver seat of the vehicle 25 and the steering wheel 5 may depend on size of the steering wheel 5.

The stopper means 130 may be attached to one of the first section 110 and the second section 120. In some embodiments, the stopper means 130 may be attached about the pivot joint or the hinge 121. The stopper means 130 may be stationary on the device 100 or may be configured to selectively pivot. In some embodiments, the stopper means 130 may further include a locking means (not illustrated) for locking the stopper means 130 in position. The stopper means 130 may be configured for contact with the wheel-section 10 of the steering wheel 5 when the first clamp half 114 and the second clamp half 124 are clamped to the wheel-section 10. The stopper means 130 may be configured to, at least substantially, prevent the first clamp half 114 and the second clamp half 124 from being moved from the locked-clamp position 108 to the open-clamp position 106 when engaged with the steering wheel 5. The stopper means 130 may achieve this physically (by physically inhibiting movement of the first clamp half 114 and the second clamp half 124) or may cause an alert to prevent an intruder from continuing with the theft.

When the first clamp half 114 and the second clamp half 124 are clamped to the wheel-section 10 of the steering wheel 5, movement of the first handle 112 and the second handle 122 to place the first clamp half 114 and the second clamp half 124 into the open-clamp position 106 may force the stopper means 130 into the center-section 15 of the steering wheel 5. This may prevent the first clamp half 114 and the second clamp half 124 from being placed into the open-clamp position 106. Preferably, the stopper means 130 may be sturdy, durable and strong to resist pressure thereon and prevent movement of the device 100. In some embodiments, the stopper means 130 may include the metal material. The metal material may be the same metal materials as discussed above, or different metal materials. The stopper means 130 is also not limited to the metal material.

Preferably, the stopper means 130 may include a stopper rod 132. As shown, the stopper rod 132 may include a substantially curved profile 135. When the first clamp half 114 and the second clamp half 124 are clamped to the wheel-section 10 of the steering wheel 5, the stopper rod 132 (the curved profile 135 of the stopper rod 132) may include a concave downward shape 136, such that movement of first handle 112 and the second handle 122 to place the first clamp half 114 and the second clamp half 124 into the open-clamp position 106 forces the stopper rod 132 (specifically, a distal end 134 of the stopper rod 132) into the center-section 15 of the steering wheel 5. As above, this may substantially prevent the first clamp half 114 and the second clamp half 124 from being placed into the open-clamp position 106.

Further, in some embodiments, when the stopper rod 132 (or stopper means 130) is forced into the center-section 15 of the steering wheel 5, it may activate a horn of the vehicle 25 to alert an owner of the vehicle 25, or passersby, as to unauthorized movement of the device 100. In addition, the stopper rod 132 may include a nonslip section 133 at the distal end 134 thereof, such as a rubber, silicone, etc. piece. The nonslip section 133 may further prevent the clamp halves (114, 124) from being placed into the open-clamp position 106 and/or allow the stopper rod 132 (or stopper means 130) to exact more precise contact with the wheel-section 10 of the steering wheel 5.

Referring now to FIG. 7 showing a flow diagram illustrating method 700 of using a device for at least substantially inhibiting unauthorized movement of a steering wheel in a vehicle, according to an embodiment of the present disclosure. In particular, the method 700 may include one or more components or features of the device 100 as described above. As illustrated, the method of use 700 may include the steps of: step one 701, providing the device as above; step two 702, placing the first clamp half and the second clamp half about any area of wheel-section of the steering wheel, the first clamp half and the second clamp half being in the open-clamp position; step three 703, moving the first handle and the second handle relative to each other to place the first clamp half and the second clamp half into the locked-clamp position; step four 704, clamping the first clamp half and the second clamp half onto said any area of wheel-section of the steering wheel; and step five 705, substantially inhibiting movement of the steering wheel.

Further, as above, when the first clamp half 114 and the second clamp half 124 are attached to a bottom-center of the wheel-section 10 of the steering wheel 5 in the locked-clamp position 108, at least one of the first handle 112 and the second handle 122 may be wedged between a driver seat 30 of the vehicle 25 and the steering wheel 5, thereby substantially inhibiting 706 unauthorized entrance to the vehicle 25.

It should be noted that step 706 (step six) is an optional step and may not be implemented in all cases. Optional steps of method 700 are illustrated using dotted lines in FIG. 7 so as to distinguish them from the other steps of method 700. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for at least substantially inhibiting unauthorized movement of a steering wheel in a vehicle and/or at least substantially inhibiting unauthorized entrance to the vehicle are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for at least substantially inhibiting unauthorized movement of a steering wheel in a vehicle, the steering wheel including a wheel-section and a center-section, the device comprising:
a first section including a first handle and a first clamp half;
a second section including a second handle and a second clamp half, the second section being pivotably attached to the first section such that movement of the first handle and the second handle relative to each other selectively moves the first clamp half and the second clamp half between an open-clamp position and a locked-clamp position, the locked-clamp position including the first clamp half and the second clamp half being clamped to an area of the wheel-section of the steering wheel, thereby at least substantially inhibiting the unauthorized movement of the steering wheel; and
a stopper means attached to one of the first section and the second section, the stopper means being configured for contact with the wheel-section of the steering wheel when the first clamp half and the second clamp half are clamped to the wheel-section.

2. The device of claim 1, wherein when the first clamp half and the second clamp half are clamped to the wheel-section of the steering wheel, movement of first handle and the second handle to place the first clamp half and the second clamp half into the open-clamp position forces the stopper means into the center-section of the steering wheel.

3. The device of claim 2, wherein the stopper means includes a stopper rod.

4. The device of claim 3, wherein the stopper rod includes a nonslip section at a distal end thereof.

5. The device of claim 4, wherein the stopper rod includes a substantially curved profile.

6. The device of claim 5, wherein when the first clamp half and the second clamp half are clamped to the wheel-section of the steering wheel, the stopper rod includes a concave downward shape, such that movement of first handle and the second handle to place the first clamp half and the second clamp half into the open-clamp position forces the stopper rod into the center-section of the steering wheel.

7. The device of claim 6, wherein the first section and the second section are attached via a hinge.

8. The device of claim 7, wherein the first clamp half and the second clamp half are configured to clamp onto any area of the wheel-section of the steering wheel.

9. The device of claim 8, wherein when the first clamp half and the second clamp half are attached to a driver-door side of the wheel-section in the locked-clamp position, the first handle and the second handle at least substantially inhibit unauthorized entrance to the vehicle.

10. The device of claim 1, wherein the first handle and the second handle include a substantially flat profile.

11. The device of claim 10, wherein the first handle and the second handle include a rectangular shape.

12. The device of claim 9, wherein the first clamp half and the second clamp half each include a substantially arcuate configuration.

13. The device of claim 12, wherein the first clamp half and the second clamp half form a substantially circular aperture when in the locked-clamp position, wherein the circular aperture is sized to securely encompass the wheel-section of the steering wheel.

14. The device of claim 13, wherein the first clamp half is configured to circumscribe a first half of the wheel-section of the steering wheel and the second clamp half is configured to circumscribe a second half of the wheel-section of the steering wheel.

15. The device of claim 14, wherein the first clamp half and the second clamp half are configured to clamp to a variety of steering wheel sizes.

16. The device of claim 1, wherein the device further includes a numerical lock system configured for selectively unlocking the first clamp half and the second clamp half from the locked-clamp position.

17. The device of claim 16, wherein the numerical lock system utilizes a sequence of at least two numbers.

18. A device for at least substantially inhibiting unauthorized movement of a steering wheel in a vehicle, the steering wheel including a wheel-section, comprising:
a first section including a first handle and a first clamp half, the first section further including a substantially flat profile and a rectangular shape;
a second section including a second handle and a second clamp half, the second section further including the substantially flat profile and the rectangular shape, the second section being pivotably attached to the first section via a hinge, such that movement of the first handle and the second handle relative to each other selectively moves the first clamp half and the second clamp half between an open-clamp position and a locked-clamp position, the locked-clamp position including the first clamp half and the second clamp half being clamped to any area of the wheel-section of the steering wheel, thereby at least substantially inhibiting movement of the steering wheel, the first clamp half and the second clamp half each both include a substantially arcuate configuration, the first clamp half and the second clamp half form a substantially circular configuration when in the locked-clamp position, the first clamp half being configured to circumscribe a first half of the wheel-section of the steering wheel and the second clamp half being configured to circumscribe a second half of the wheel-section of the steering wheel; and
a stopper rod attached to one of the first section and the second section, the stopper rod including a substantially arcuate configuration, the stopper rod being configured for contact with the wheel-section of the steering wheel when the first clamp half and the second clamp half are clamped to the wheel-section;
a numerical lock system configured for selectively unlocking the first clamp half and the second clamp half from the locked-clamp position;
wherein the numerical lock system utilizes a sequence of at least two numbers;
wherein when the first clamp half and the second clamp half are clamped to the wheel-section of the steering wheel, the arcuate configuration faces downward, such that movement of first handle and the second handle to place the first clamp half and the second clamp half into the open-clamp position forces the stopper rod into the steering wheel; and
wherein when the first clamp half and the second clamp half are attached to a driver-door side of the wheel-section in the locked-clamp position, the first handle and the second handle at least substantially inhibit unauthorized entrance to the vehicle.

19. A method of using a device for at least substantially inhibiting unauthorized movement of a steering wheel in a vehicle, the steering wheel including a wheel-section and a center-section, the method comprising the steps of:
providing the device, the device including:
a first section including a first handle and a first clamp half;
a second section including a second handle and a second clamp half, the second section being pivotably attached to the first section such that movement of the first handle and the second handle relative to each other selectively moves the first clamp half and the second clamp half between an open-clamp position and a locked-clamp position, the locked-clamp position including the first clamp half and the second clamp half being clamped to an area of the wheel-section of the steering wheel, thereby at least substantially inhibiting the unauthorized movement of the steering wheel; and
a stopper means attached to one of the first section and the second section, the stopper means being configured for contact with the wheel-section of the steering wheel when the first clamp half and the second clamp half are clamped to the wheel-section;
placing the first clamp half and the second clamp half about any area of wheel-section of the steering wheel, the first clamp half and the second clamp half being in the open-clamp position;
moving the first handle and the second handle relative to each other to place the first clamp half and the second clamp half into the locked-clamp position;
clamping the first clamp half and the second clamp half onto said any area of wheel-section of the steering wheel; and
substantially inhibiting movement of the steering wheel.

20. The method of claim 19, wherein when the first clamp half and the second clamp half are attached to a driver-door side of the wheel-section in the locked-clamp position, the first handle and the second handle at least substantially inhibit unauthorized entrance to the vehicle.
